(19) United States
(12) Patent Application Publication
(10) Pub. No.: US 2006/0211358 A1
(43) Pub. Date: Sep. 21, 2006

(54) Integrated duct and monitor housing

(75) Inventor: Robert Joseph Hachmann, Peosta, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/357,232

(22) Filed: Feb. 17, 2006

Related U.S. Application Data
(60) Provisional application No. 60/659,329, filed on Mar. 7, 2005.

(51) Int. Cl. B60H 1/00

(52) U.S. Cl. 454/69

(57) ABSTRACT

An integrated duct and monitor housing having ductwork for environmental control via the flow of air and mounting provisions for a monitor. The entire arrangement is suitable for use in a vehicle. The housing includes an air inlet a housing mounting structure for anchoring the housing to a portion of a structure; a monitor mounting structure for anchoring a monitor to the housing and an air outlet. The air inlet, the housing monitor structure, the monitor mounting structure, the monitor mounting structure, and the air outlet form an integrated housing, the integrated housing being hollow throughout and allowing air flow throughout the housing.

This application claims the benefit under 35 U.S.C. §119(e) of U.S. Provisional Patent Application No. 60/659,329 which was filed 7 Mar. 2005 and is hereby incorporated by reference herein.

### FIELD OF THE INVENTION

The invention relates to housings and, more particularly, relates to monitor housings with integrated ducts for environmental control, particularly for heavy machinery such as, for example, motor graders.

### BACKGROUND OF THE INVENTION

Various types of monitor housings exist for heavy, off road equipment. Much of the prior art includes multiple sets of distribution ducts with separate instrument housing, specially designed duct housing separate from any instrument housing, or integrated duct housing with large plenum areas as well as large mounting areas, separate from the air flow channels, where one or more instruments or instrument panels may be mounted.

### SUMMARY OF THE INVENTION

As indicated above, much of the prior art combines air flow channels, i.e., air ducts, with the mounting structure. Such an arrangement tends to save space. However, in each case, space and cost is increased by the larger and more complex mounting structures that are separate from the duct structure. These arrangements tend to result in greater space requirements and costs due to the greater amount of material and complexity involved in the design of separate structures. Described and herein is an integrated duct and monitor housing that is hollow throughout its structure and provides monitor attachment points only at specific points on the ductwork. This tends to save space and reduce costs as no large plenum areas or separate mounting structures are required and air moves quickly through the structure with a minimum loss of energy to the materials of the housing.

### BRIEF DESCRIPTION OF THE DRAWINGS

Embodiments of the invention will be described in detail, with references to the following figures, wherein:

FIG. 1 is an oblique frontal view of an exemplary embodiment of the housing of the invention;

FIG. 2 is an oblique rear view of the housing illustrated in FIG. 1;

FIG. 3 is an oblique frontal view of the housing of FIG. 1 with a monitor and additional structure attached;

FIG. 4 is a sectional view taken along lines 4-4 of FIG. 1;

FIG. 5 is a sectional view taken along lines 5-5 of FIG. 1;

FIG. 6 is a sectional view taken along lines 6-6 of FIG. 1;

FIG. 7 is a sectional view taken along lines 7-7 of FIG. 1; and

FIG. 8 is a sectional view taken along lines 8-8 of FIG. 1.

### DESCRIPTION OF THE PREFERRED EMBODIMENT

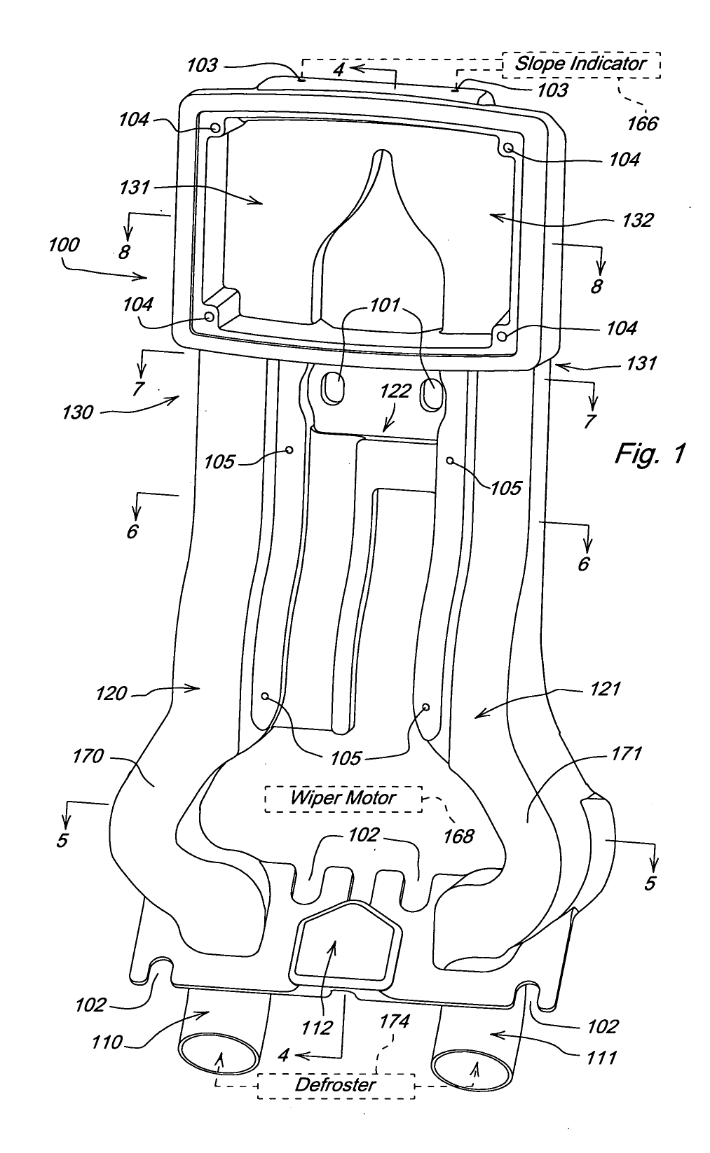

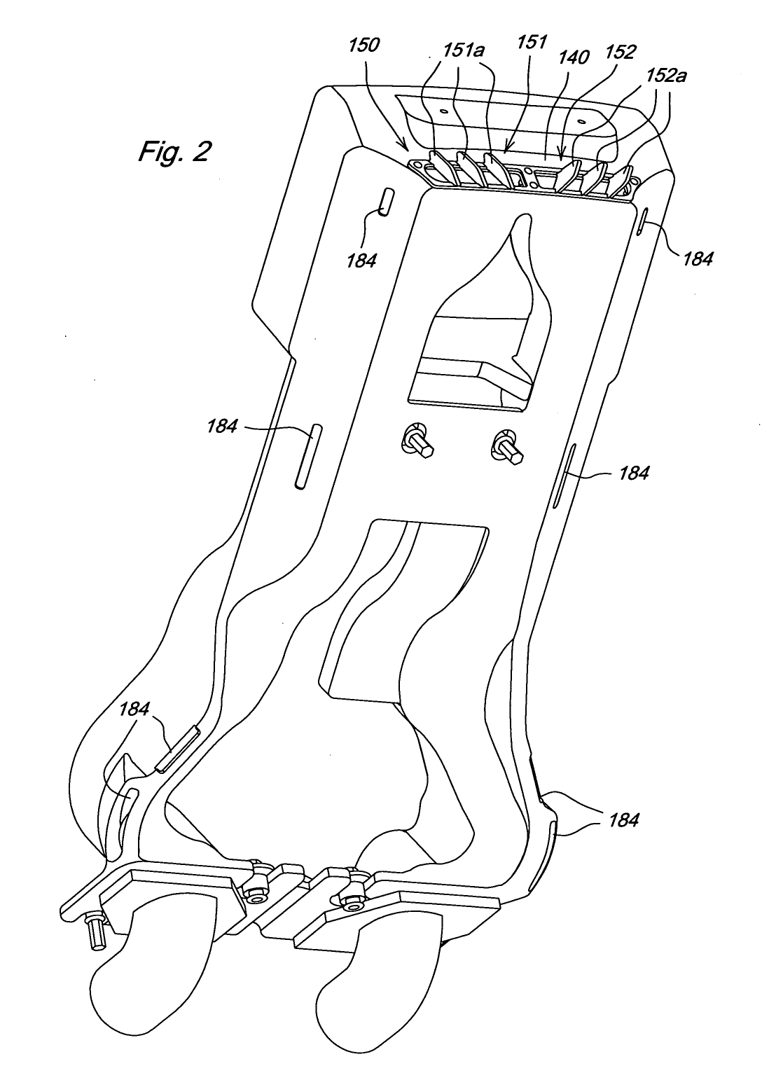

FIGS. 1 and 2 illustrate an exemplary embodiment of an integrated duct and monitor housing 100 of the invention for a construction vehicle such as, for example, a motor grader. The integrated duct and monitor housing 100 includes: air inlets 110 and 111; a first small mounting structure 112; second and third duct portions 120 and 121; a second mounting structure 122; fourth and fifth duct portions 130 and 131; a third mounting structure 132; and air outlets 151 and 152 formed in an air outlet cover or louver 150 and configured as air vents with air vanes 151a and 152a. The integrated duct and monitor housing 100 is hollow throughout; air flows throughout its structure.

Mounting holes 101 and mounting slots 102 of the first and second mounting structures 112 and 122 are for the purpose of anchoring the integrated duct and monitor housing 100 to a portion of the structure of the vehicle (not shown). The first and second mounting structures 112 and 122 thus provide, alone or in combination, a housing mounting structure for anchoring the housing 100 the vehicle structure.

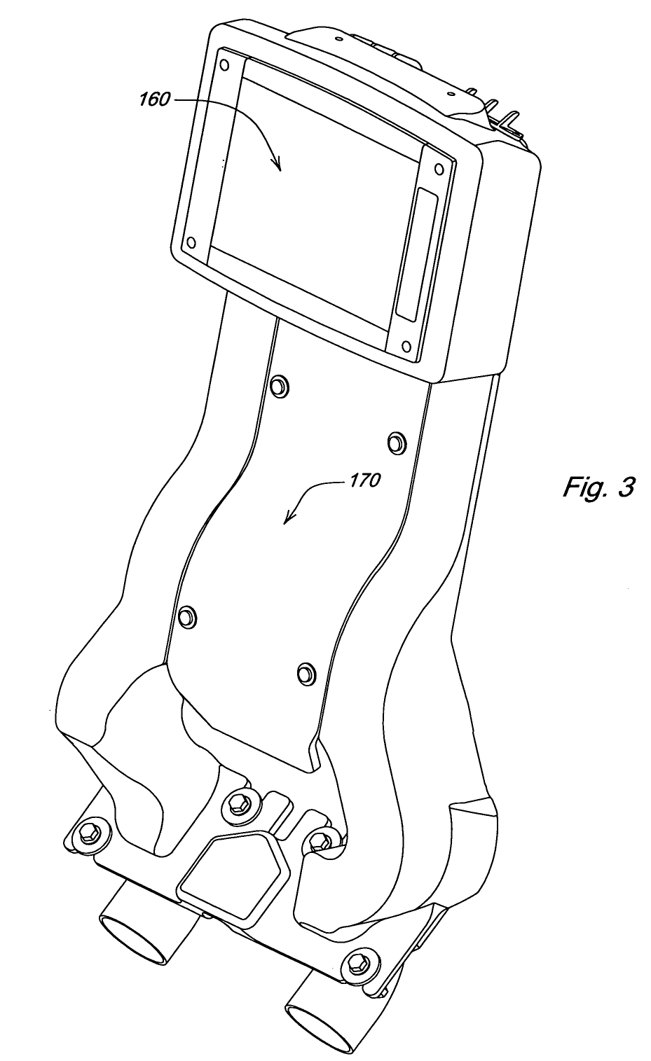

Mounting holes 104 of the third mounting structure 132 are anchoring points for securing a monitor 160 to the integrated duct and monitor housing. The third mounting structure 132 thus acts as a monitor mounting structure for anchoring a monitor 160 (see FIG. 3).

Mounting inserts 103 at the top of the housing 100 provide anchoring points for securing, for example, a slope indicator 166 that indicates the slope of the ground on which the motor grader or other construction vehicle is operating. Finally, mounting inserts 105 are anchoring points for affixing a protective and decorative cover 170 to the integrated duct and monitor housing 100, as illustrated in FIG. 3, to cover portions of a wiring harness from the monitor 160 and a windshield wiper motor 168 affixed to the vehicle structure (not shown) and received in a wiper motor mounting space 169 defined between bowed portions 170 and 171 of the second and third duct portions 120 and 121 that are bowed laterally outwardly away from one another. Inclusion of the bowed portions 170 and 171 thus promotes space economy, which may be especially useful in a vehicle environment.

In operation, air from an air source such as, for example, a windscreen defroster 174 enters the inlets 110 and 111 a greater portion of which continues through duct portions 120 and 121. However, a small portion of the air flowing through air inlets 110 and 111 flows into the first small mounting structure 112 which is hollow. Eventually, all of the air flowing into the first small mounting structure 112 also flows through duct portions 120 and 121 toward the second mounting structure 122 where a small portion of it flows into the second mounting structure 122 before traveling a relatively short distance, via duct portions 130 and 131 to a third mounting structure 132 where a small portion of air flows through the third mounting structure 132 and the remaining air flows through the duct portions 130 and 131 and exits the vents 151 and 152. All air entering the mounting structure 132 also eventually exits the vents 151 and 152 as the hollow mounting structure 132 directly communicates with the vents 151 and 152.

The integrated duct and monitor housing 100 is thoroughly hollow and of sufficient strength to be anchored to the vehicle structure and to rigidly support the monitor 160. Thus, optimal space savings and efficiency in the movement of air is possible.

The air inlet 110, duct portions 120 and 130, and vent 152 cooperate to provide a first duct defining therein a first air flowpath 176 through the housing 100 and the air inlet 111, duct portions 121 and 131, and vent 151 cooperate to provide a second duct defining therein a second air flowpath 178 through the housing 100. The first and second air flowpaths are in flow-parallel with one another to conduct air supplied by the defroster 174 through the housing 100.

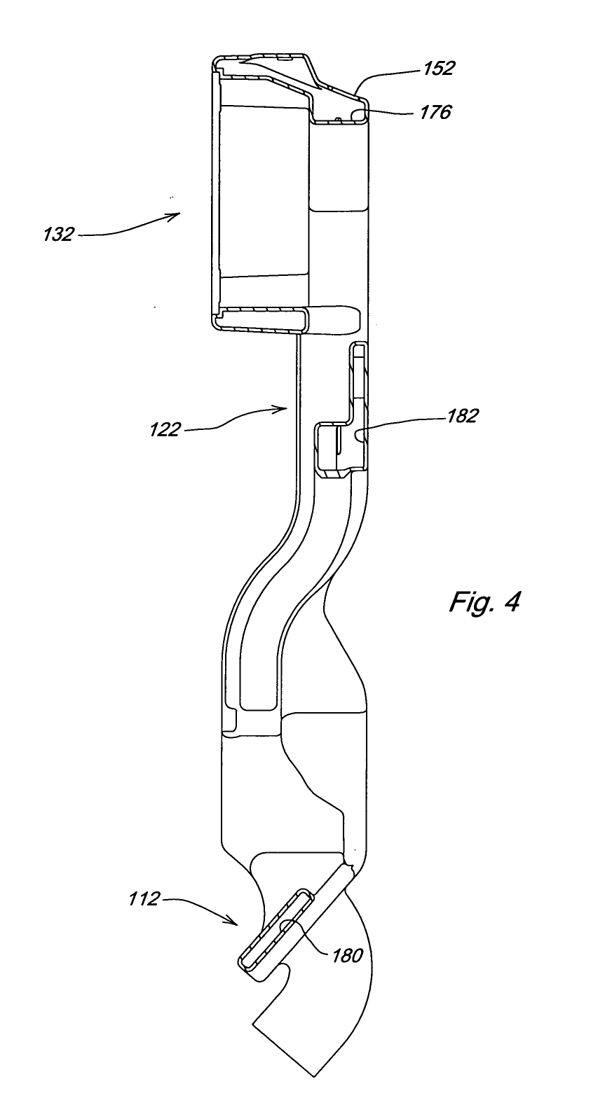

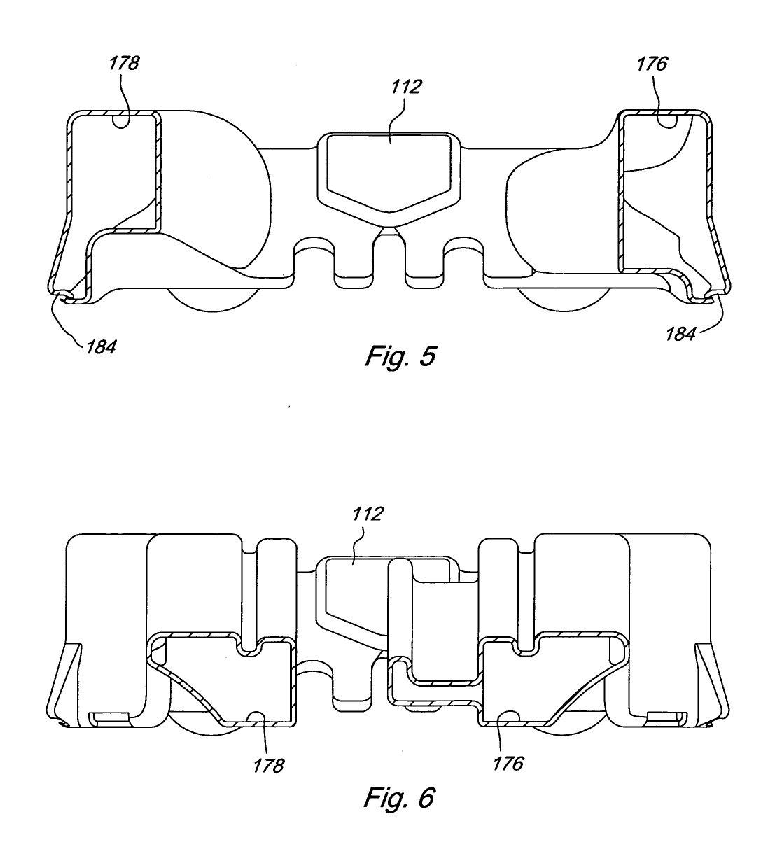

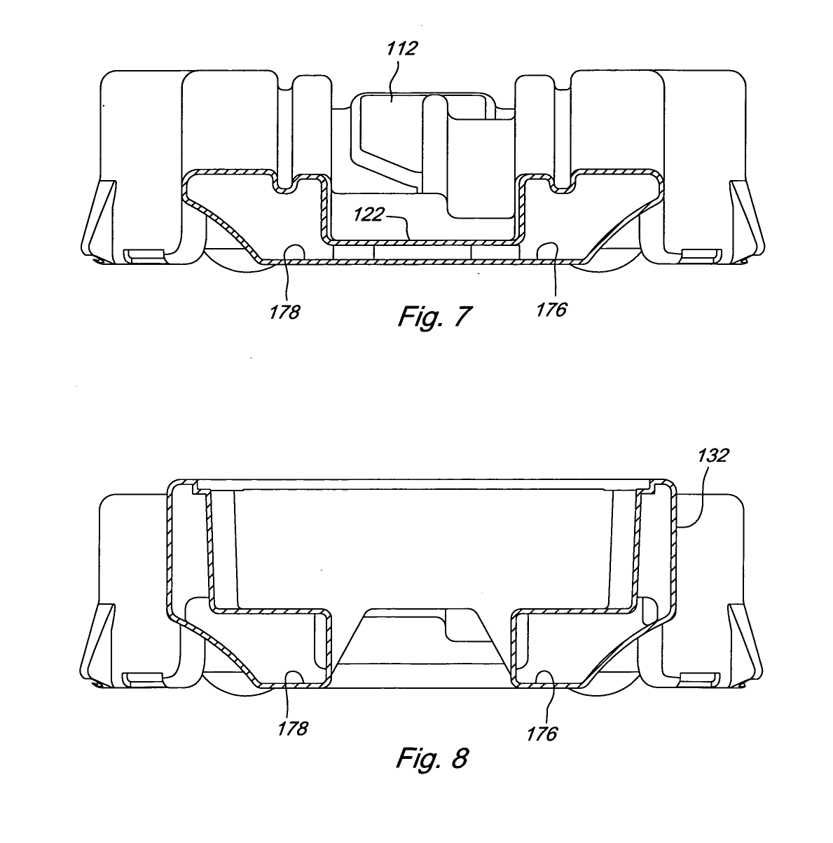

As mentioned above, the mounting structures 112 and 122, may be hollow (see FIG. 4) due to, for example, the manufacturing process used to create the housing 100. However, third and fourth air flowpaths 180 and 182 defined by the structures 112 and 122, respectively, are sufficiently restricted due to their cross-sectional flow areas in comparison with the larger cross-sectional flow areas of the first and second air flowpaths 176 and 178 (see FIGS. 5-8) so as to limit cross-flow between the first and second air flowpaths 176 and 178 through the third and fourth air flowpaths 180 and 182. Since the air flow will tend to follow the path of least resistance, most of the air will remain in the first and second air flowpaths 176 and 178 rather than passing through the third and fourth air flowpaths 180 and 182. As such, the first and second air flowpaths 176 and 178 are effectively discrete from one another in a lower portion of the housing 100 (i.e., the portion of the housing 100 below the third mounting structure 132) so as to deliver a balanced flow of air to the first and second vents 151 and 152 and thus a balanced output of air to first and second regions of the windscreen.

The housing 100 may be constructed such that no cross-flow is allowed between the first and second flowpaths 176 and 178. This may be accomplished, for example, by making each mounting structure 112, 122, and 132 non-hollow or with an internal partition blocking communication between the first and second air flowpaths.

Illustratively, the housing 100 is a one-piece structure. It may be made of a variety of materials including, but not limited to, plastic materials by any suitable manufacturing process such as, for example, injection molding.

Additional air outlets may be formed in the first and/or second duct. Exemplarily, as shown in FIGS. 2 and 5, each of the first and second ducts has a number of air outlets 184 formed therein for discharge of air to defrost a lower front glass (not shown) of the vehicle.

Having described the preferred embodiment, it will become apparent that various modifications can be made without departing from the scope of the invention as defined in the accompanying claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A duct and monitor housing, comprising:
an air inlet;
a housing mounting structure for anchoring the duct and monitor housing to a portion of a structure;
a monitor mounting structure for anchoring a monitor to the duct and monitor housing; and
an air outlet, the air inlet, the housing mounting structure, the monitor mounting structure, and the air outlet forming an integrated housing, the integrated housing being hollow throughout.

2. The duct and monitor housing of claim 1, wherein the air inlet comprises two air inlets.

3. The duct and monitor housing of claim 1, comprising a mounting insert for mounting a protective cover to the duct and monitor housing.

4. The duct and monitor housing of claim 1, comprising a mounting insert for mounting an indicator to the duct and monitor housing.

5. The duct and monitor housing of claim 1, comprising a first air flowpath and a second air flowpath in flow-parallel with the first air flowpath, wherein the air inlet comprises first and second air inlets, the air outlet comprises first and second air outlets, the first air flowpath extends from the first air inlet to the first air outlet, and the second air flowpath extends from the second air inlet to the second air outlet.

6. The duct and monitor housing of claim 5, wherein a third air flowpath connects the first air flowpath and the second air flowpath and is more restricted than each of the first and second air flowpaths.

7. The duct and monitor housing of claim 5, wherein the third air flowpath is defined in the housing mounting structure.

8. The duct and monitor housing of claim 1, comprising a hollow first duct and a hollow second duct cooperating with the first duct to define therebetween a wiper motor mounting space for a wiper motor.

9. The duct and monitor housing of claim 7, wherein each of the first and second ducts comprises a bowed portion, and the bowed portions bow outwardly away from one another to define the wiper motor mounting space therebetween.
